(19) United States
(12) Patent Application Publication
(10) Pub. No.: US 2022/0365547 A1
(43) Pub. Date: Nov. 17, 2022

(54) CONTROL DEVICE FOR A FLUID HEATING SYSTEM

(71) Applicant: Valeo Systemes Thermiques, Le Mesnil Saint-Denis (FR)

(72) Inventors: Jonathan Fournier, Le Mesnil Saint-Denis (FR); Rémi Carlicchi, Le Mesnil Saint-Denis (FR)

(73) Assignee: Valeo Systemes Thermiques, Le Mesnil Saint-Denis (FR)

(21) Appl. No.: 17/623,347

(22) PCT Filed: Jun. 24, 2020
(86) PCT No.: PCT/FR2020/051101

§ 371 Date: Dec. 28, 2021

(30) Foreign Application Priority Data
Jun. 28, 2019 (FR) FR1907080

(51) Int. Cl. G05D 23/19; H05B 1/02; G05D 23/24

(52) U.S. Cl. CPC G05D 23/1931; H05B 1/0244; G05D 23/24; H05B 1/0236

(57) ABSTRACT

The invention concerns a control device comprising: a first electronic switch (2) suitable for being connected to an electric heating element (101) and a second electronic switch (3) suitable for being connected to an electric heating element (101), a sensor for measuring a first temperature (T1) and a microcontroller (4) associated with the first electronic switch (2), the microcontroller (4) being configured to open or close the first switch (2) depending on the first measured temperature value (T1), a sensor for measuring a second temperature (T2) and a logic control module (5) associated with the second electronic switch (3) and comprising a comparator (6) arranged to compare the second measured temperature (T2) with a threshold, the module (5) being configured to open or close the second switch (3) depending on the result of the comparison.

### TECHNICAL FIELD

The invention relates to a control device for a system for heating a fluid, preferably a liquid, for a motor vehicle, in particular an electric or hybrid vehicle.

### PRIOR ART

In a known manner, such a system for heating a fluid, preferably a liquid, comprises an electric heating element and a chamber formed so that the fluid is heated by said electric element in the chamber.

The device for controlling the electric heating element generally includes at least one power transistor, supplied with a high voltage and a gate of which is driven by a circuit supplied with a low voltage. The high voltage is for example of the order of 350 V while the low voltage is of the order of 12 V.

In the event of a failure of the power transistor, the heating device may operate continuously, this creating, when the water begins to boil and evaporates, a risk of fire that is unacceptable, especially in view of the standard ISO 26262.

The aim of the present invention is to remedy this drawback.

### SUMMARY

A device is provided for controlling a system for heating a fluid, preferably a liquid fluid, for a motor vehicle, comprising at least one electric heating element configured to heat said fluid, the control device comprising a first electronic switch capable of being connected to the electric heating element and a second electronic switch capable of being connected to the electric heating element, a sensor for measuring a first temperature and a microcontroller both associated with the first electronic switch, the microcontroller being configured to open or close the first switch depending on the measured value of the first temperature, a sensor for measuring a second temperature and a logic control module both associated with the second electronic switch and comprising a comparator arranged to compare the measured second temperature with a threshold, the module being configured to open or close the second switch depending on the result of the comparison.

According to another aspect, the module is configured to open the second electronic switch if the second temperature is greater than a threshold.

According to another aspect, the module comprises a digital coupler for connection between the microcontroller and the logic control module, configured to communicate the measured second temperature to the microcontroller and/or to activate or deactivate the second electronic switch.

According to another aspect, the microcontroller is configured to open the first electronic switch if an absolute value of a difference between the values of the measured first and second temperatures is greater than a threshold.

According to another aspect, the logic control module comprises another comparator for comparing the first temperature with a threshold value, and being configured to open the second electronic switch if the first temperature is greater than a threshold.

According to another aspect, the logic control module comprises a means for checking the consistency of the first and second temperatures, configured to open the second electronic switch if the first temperature is different from the second temperature.

According to another aspect, the device comprises a switched-mode power supply.

According to another aspect, a system for heating a fluid, in particular a liquid, comprising an electric heating element and a control device such as described above is provided.

### BRIEF DESCRIPTION OF THE DRAWINGS

Other features, details and advantages will become apparent on reading the detailed description below, and on analyzing the appended drawings, in which:

FIG. 1 schematically illustrates a control device of a heating system according to a first embodiment.

FIG. 2 schematically illustrates a comparator of the control device of FIG. 1.

FIG. 3 schematically illustrates a control device of a heating system according to a second embodiment.

FIG. 4 schematically illustrates a control device of a heating system according to a third embodiment.

FIG. 5 illustrates the control device of FIG. 4 according to a first variant.

FIG. 6 illustrates a control device of FIG. 4 according to a second variant.

### DESCRIPTION OF EMBODIMENTS

The drawings and the description below essentially contain elements of a certain nature. They may therefore not only serve to better understand the present disclosure, but also contribute to its definition, if applicable.

In the remainder of the description, elements that are identical or perform identical functions have been designated with the same reference sign. In the present description, for the sake of conciseness, these elements are not described in detail in each embodiment. Rather, only the differences between the variant embodiments are described in detail.

As may be seen in the figures, one subject of the invention is a control device 1 for a system for heating a fluid 100, preferably a liquid fluid, for a motor vehicle.

The heating system 100 comprises an electric heating element, 101. The heating element 101 is advantageously a cylindrical heating tube comprising a heating resistor R of the screen-printed track type, of the sheathed resistor type or of the type with a positive temperature coefficient.

The heating system 100 also comprises a chamber 102 through which the liquid fluid F, for example a glycol-water mixture, flows and in which the heating element 101 is immersed, so that the fluid F is heated by the electric heating element 101 in the chamber 102.

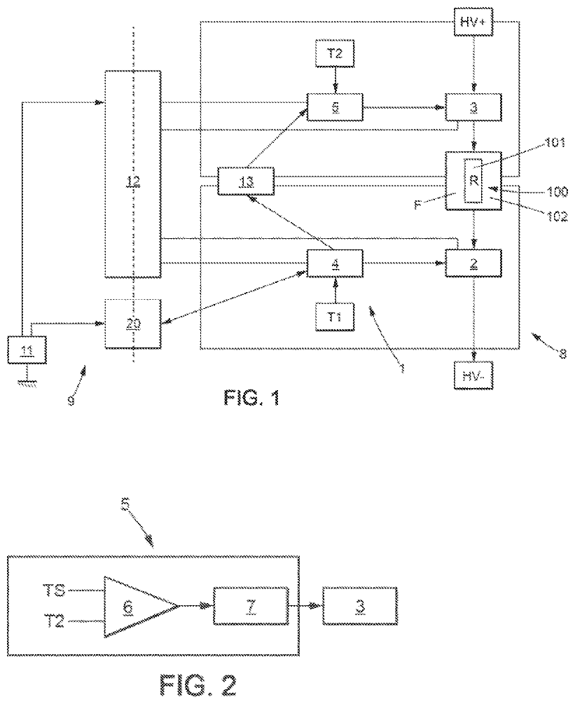

The first embodiment is described with reference to FIGS. 1 and 2.

As may be seen in FIG. 1, the control device 1 comprises a first electronic switch 2 and a second electronic switch 3.

Preferably, the first and second switches 2, 3 are IGBT power transistors (IGBT standing for Insulated Gate Bipolar Transistor).

The control device 1 also comprises a microcontroller 4 associated with the first switch 2 and configured to open or close the first switch 2.

For example, the microcontroller 4 applies a so-called low voltage, in particular of the order of 12 V, to the gate of the transistor 2 to close the transistor 2 and a zero voltage to open the transistor 2.

The control device 1 also comprises a temperature sensor, for example of the PTC or NTC type, for measuring a first temperature T1. The temperature T1 is measured in or near the chamber 102 in order to directly or indirectly determine the temperature of the fluid flowing through the heating system 100.

The microcontroller 4 is configured to open the transistor 2 when T1 is greater than a threshold value.

As may also be seen from FIGS. 1 and 2, the control device 1 comprises a logic control module 5 for the second switch 3.

It will be noted that the logic control module 5 differs from a microcontroller in that it comprises fewer signal-processing stages. In particular, the module comprises no analog/digital converter. In addition, there is a direct connection between the current source and the comparator(s) with which it is equipped, as will be detailed. The logic control module has only the function for which it was designed, unlike the microcontroller which operates according to its programming (software).

Unlike the prior art, the logic control module 5 allows redundancy to be provided for safety's sake without a second microcontroller being required. Thus, certain signal-processing stages are eliminated, this making the control device more robust.

The module 5 comprises a comparator 6 arranged to compare a measured second temperature T2 with a threshold, and a means 7 for controlling the gate of the transistor 3, connected to the comparator 5 and configured to open or close the second switch 3 depending on the result of the comparison.

The control device 1 also comprises a temperature sensor, for example of the PTC or NTC type, for measuring the second temperature T2. The temperature T2 is measured in or near the chamber 102 in order to directly or indirectly determine the temperature of the fluid flowing through the heating system 100.

The gate control means 7 is configured to open the transistor 3 when T2 is greater than a threshold value.

As may also be seen in FIG. 1, the transistors 2, 3 are connected in series to the electric heating element 101 between two potentials denoted HV+ and HV− (HV standing for High Voltage), forming a so-called high-voltage circuit 8. The voltage HV+ is for example of the order of 350 V.

As illustrated in FIG. 1, the control device 1 comprises a low-voltage circuit 9 comprising a so-called flyback switched-mode power supply comprising in a known manner a transformer 12 connected to an electrical source 11, and allowing the microcontroller 4, the module 5, and the transistors 2 and 3 to be electrically powered.

The electrical source is said to be low voltage, and delivers a voltage comprised between 5 V and 20 V, and for example of 12 V or 15 V.

As also illustrated in FIG. 1, the control device 1 also comprises a digital coupler 13 between the microcontroller 4 and the module 5.

According to this first embodiment, the digital coupler 13 ensures communication between the microcontroller 4 and the module 5, so that the microcontroller 4 drives the activation of the second transistor 3 via the module 5. To do this, the module comprises an AND logic between the signal of the temperature T2 and an on/off signal sent by the microcontroller 4 via the coupler 13.

Thus, in the event of failure, the temperature T1 and/or the temperature T2 becomes greater than the threshold value and the first transistor 2 and/or the second transistor 3 opens, by virtue of the microcontroller 4 and of the module 5, respectively, this allowing any risk of fire to be prevented.

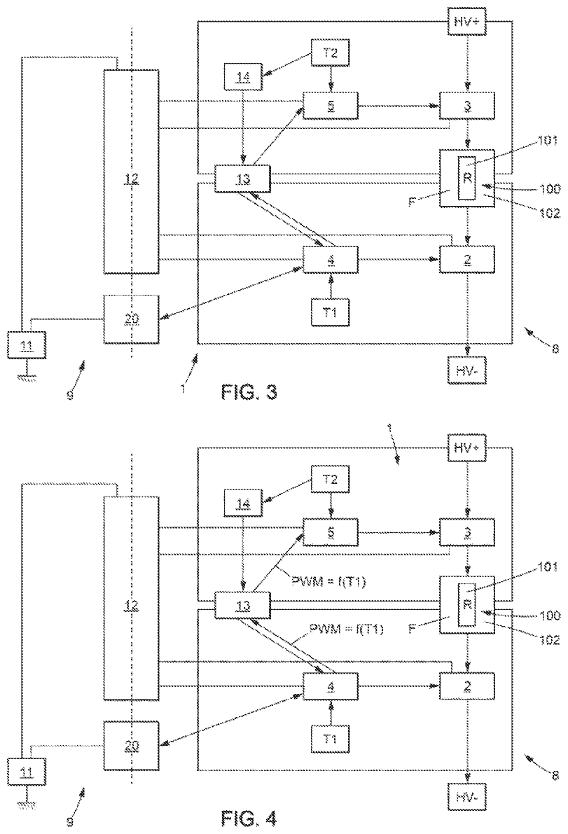

The second embodiment is described with reference to FIG. 3.

Elements 1 to 13 of the control device 1 of the second embodiment have already been described with reference to FIG. 1. The elements 100-102 of the heating system have also already been described.

As may be seen in FIG. 3, the control device 1 comprises an analog-to-digital converter 14 for transmitting the temperature T2 to the microcontroller 4 via the digital coupler 13. The physical bus may be an I2C bus (I2C standing for Inter-Integrated Circuit) or an SPI bus (SPI standing for Serial Peripheral Interface).

Advantageously, in this case, the microcontroller 4 may be configured to check the consistency of the temperatures T1 and T2 and to open the first transistor 2 if T1 and T2 are inconsistent (their difference being greater, in absolute value, than a threshold, which may be set to zero).

The third embodiment is described with reference to FIGS. 4 to 6.

Elements 1 to 14 of the control device 1 of the third embodiment have already been described with reference to FIG. 3. The elements 100-102 of the heating system have also already been described.

As illustrated in FIG. 4, a PWM signal (PWM standing for Pulse Width Modulation) the duty cycle of which is modulated depending on the temperature T1, is transmitted from the microcontroller 4 to the module 5 via coupler 13.

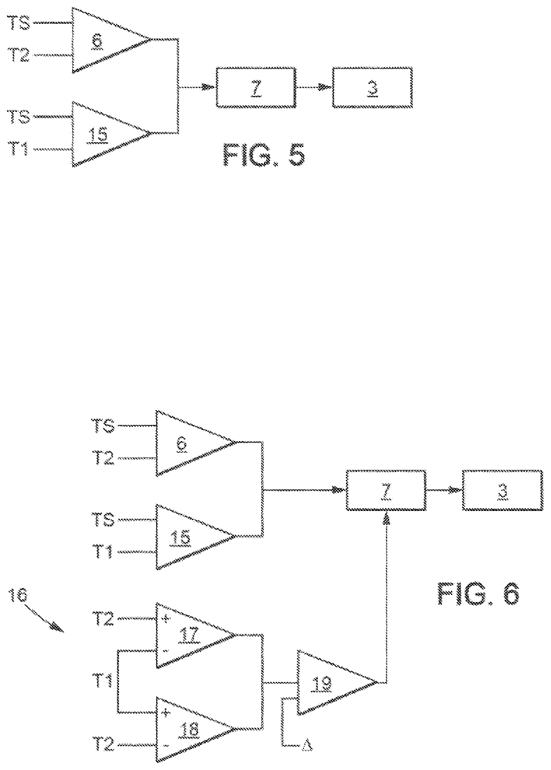

In FIG. 5, the module 5 comprises, in addition to the comparator 6, a comparator 15 arranged to compare the first temperature T1, by virtue of the PWM signal. The comparator 15 is connected to the means 7 for controlling the gate of the transistor 3, so that the second transistor 3 is opened if T1 is greater than the threshold or if T2 is greater than the threshold.

In FIG. 6, the module 5 comprises, in addition to the comparators 6 and 15, a means 16 for comparing the temperatures T1 and T2, which is connected to the means 7 for controlling the gate of the transistor 3, so that the second transistor 3 is opened if the temperatures T1 and T2 differ from a threshold, which may be set to zero.

As may be seen in FIG. 6, the means 16 comprises a first subtractor 17, a second subtractor 18 and a comparator 19.

The first subtractor 17 has signal T1 as positive input and signal T2 as negative input, while the second subtractor has signal T2 as positive input and signal T1 as negative input, this making it possible to compare in the comparator 19 the difference between the two temperatures to the threshold value A.

Thus, according to this variant, the means 7 for controlling the gate of the transistor 3 opens the second transistor 3 if:
the temperature T1 is greater than the threshold,
the temperature T2 is greater than the threshold, and/or
if the temperatures T1 and T2 differ.

It will be noted that the device 1 advantageously comprises, as illustrated in FIGS. 1, 3 and 4, a digital coupler 20, which is supplied by the source 11 and placed between the low-voltage circuit 9 and the microcontroller 4, in order to communicate other information regarding operation of the control device 1.

Thus, by virtue of the present invention, it is possible to reliably detect failure of the power transistors, this making it possible to preserve the associated heating system and to protect the occupants of the motor vehicle equipped with the system.

1. A device for controlling a system for heating a fluid for a motor vehicle, the system comprising at least one electric heating element configured to heat the fluid, the control device comprising:
a first electronic switch capable of being connected to the electric heating element and a second electronic switch capable of being connected to the electric heating element;
a first sensor for measuring a first temperature and a microcontroller both associated with the first electronic switch, the microcontroller being configured to open or close the first switch depending on the measured value of the first temperature;
a second sensor for measuring a second temperature and a logic control module both associated with the second electronic switch; and
a comparator arranged to compare the measured second temperature with a threshold, the logic control module being configured to open or close the second switch depending on the result of the comparison.

2. The device as claimed in claim 1, wherein the logic control module is configured to open the second electronic switch when the second temperature is greater than a threshold.

3. The device as claimed in claim 1, further comprising: a digital coupler for connection between the microcontroller and the logic control module, configured to communicate the measured second temperature to the microcontroller and/or to activate or deactivate the second electronic switch.

4. The device as claimed in claim 3, wherein the microcontroller is configured to open the first electronic switch if when an absolute value of a difference between the values of the measured first and second temperatures is greater than a threshold.

5. The device as claimed in claim 1, wherein the logic control module comprises another comparator for comparing the first temperature with a threshold value, and being configured to open the second electronic switch when the first temperature is greater than the threshold value.

6. The device as claimed in claim 5, wherein the logic control module comprises a means for checking the consistency of the first and second temperatures, configured to open the second electronic switch when the first temperature is different from the second temperature.

7. The device as claimed in claim 1, further comprising a switched-mode power supply.

8. A system for heating a fluid comprising: an electric heating element and a control device as claimed in claim 1.
